(19) United States
(12) Patent Application Publication
(10) Pub. No.: US 2017/0053383 A1
(43) Pub. Date: Feb. 23, 2017

(54) APPARATUS AND METHOD FOR PROVIDING 3D CONTENT AND RECORDING MEDIUM

(71) Applicant: Dae Hoon Heo, Seoul (KR)

(72) Inventor: Dae Hoon Heo, Seoul (KR)

(21) Appl. No.: 14/827,400

(22) Filed: Aug. 17, 2015

(51) Int. Cl. G06T 3/40; G06F 17/22; G06T 15/00

(52) U.S. Cl. CPC G06T 3/4092; G06T 15/005; G06F 17/2247; G06F 17/2288; G06T 2200/16

(57) ABSTRACT

Provided is an apparatus for providing a 3D content. The apparatus includes: a processor; and a memory that can be accessed by the processor, wherein the processor transmits a preview content to a client terminal, and transmits a 3D content for magnifying the preview content to the client terminal after transmitting the preview content.

### BACKGROUND OF THE DISCLOSURE

Field of the Disclosure

The present invention relates to an apparatus and a method for providing 3D content, and a recording medium thereof.

Description of the Related Art

Sellers of goods desire to facilitate the sale of goods by arousing customer's interest in goods.

A three-dimensional image for the goods is used on-line in order to arouse customer's interest in goods.

However, since the data size of the three-dimensional image is large, a lot of traffic may occur or it may take a lot of time to perform loading. Accordingly, various studies for reducing traffic or loading time have been progressed.

### SUMMARY

The present invention may provide an apparatus and a method for providing 3D content which is capable of reducing traffic or loading time due to the transmission or loading of 3D content, and a recording medium thereof.

In accordance with an aspect of the present invention, an apparatus for providing a 3D content includes: a processor; and a memory that can be accessed by the processor, wherein the processor transmits a preview content to a client terminal, and transmits a 3D content for magnifying the preview content to the client terminal after transmitting the preview content.

The client terminal displays a 2D image or a three-dimensional image corresponding to the preview content.

A 3D acceleration engine included in a web browser is installed in the client terminal, when the web browser is installed in the client terminal, and the 3D engine is able to process the preview content and the 3D content.

The processor transmits the 3D content to the client terminal, when the client terminal requests the 3D content according to an operation of an input unit of the client terminal by a user.

The preview content and the 3D content are transmitted to the client terminal, and the 3D content is stored in a memory of the client terminal without displaying the 3D content on the client terminal while the preview content is displayed on the client terminal, and the 3D content is displayed on the client terminal, when the 3D content is requested according to an operation of an input unit of the client terminal by a user.

The processor reduces a polygon of the 3D content to generate the preview content.

The processor controls a database including information related to area of a web page where the 3D content for each subscriber is displayed, and transmits the information related to area of the web page to the client terminal with the transmission of the 3D content.

A plurality of the 3D contents having a different data size are stored in a database, and the processor selects one of the plurality of the 3D content according to a type of the client terminal to transmit to the client terminal.

In accordance with another aspect of the present invention, a method for providing a 3D content implemented in a computer so as to provide the 3D content to be displayed in a client terminal, includes: transmitting a preview content to the client terminal; and transmitting the 3D content for magnifying the preview content to the client terminal after transmitting the preview content.

The client terminal displays a 2D image or a three-dimensional image corresponding to the preview content.

A 3D acceleration engine included in a web browser is installed in the client terminal, when the web browser is installed in the client terminal, and the 3D engine is able to process the preview content and the 3D content.

The 3D content is transmitted to the client terminal, when the client terminal requests the 3D content according to an operation of an input unit of the client terminal by a user.

The preview content and the 3D content are transmitted to the client terminal, and the 3D content is stored in a memory of the client terminal without displaying the 3D content on the client terminal while the preview content is displayed on the client terminal, and the 3D content is displayed on the client terminal, when the 3D content is requested according to an operation of an input unit of the client terminal by a user.

The preview content is transmitted to the client terminal after generating the preview content by reducing a polygon of the 3D content.

The method further includes reading information related to area of a web page from a database including the information related to area of the web page where the 3D content for each subscriber is displayed, wherein the information related to area of the web page is transmitted to the client terminal with the transmission of the 3D content.

The method further includes storing a plurality of 3D contents having a different data size in a database, wherein one of the plurality of the 3D contents is selected and transmitted to the client terminal according to a type of the client terminal.

In accordance with another aspect of the present invention, a non-transitory computer readable recording medium recording a program for executing functions of: transmitting a preview content to a client terminal; and transmitting a 3D content for magnifying the preview content to the client terminal after transmitting the preview content. Here, the term “non-transitory computer-readable medium” comprises all computer-readable media, with the sole exception being a transitory, propagating signal.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of a system for providing a 3D content according to an embodiment of the present invention;

FIG. 2 and FIG. 3 are diagrams illustrating various information which are stored in a database;

FIG. 4 to FIG. 6 are diagrams illustrating the transmission of preview content and 3D content which is performed between an apparatus for proving a 3D content and a client terminal according to an embodiment of the present invention;

FIG. 7 is a diagram illustrating a method for proving a 3D content according to an embodiment of the present invention; and

FIG. 8 to FIG. 13 are diagrams illustrating an example of a preview content and a 3D content displayed in a client terminal.

### DETAILED DESCRIPTION OF EXEMPLARY EMBODIMENTS

Embodiments of the present invention are described with reference to the accompanying drawings in detail. Although embodiments have been described with reference to a number of illustrative embodiments thereof, it should be understood that numerous other modifications and embodiments can be devised by those skilled in the art that will fall within the spirit and scope of the principles of the present invention.

The terms used in various embodiments are only used to describe specific various embodiments, and are not intended to limit various embodiments of the present disclosure. Singular forms are intended to include plural forms unless the context clearly indicates otherwise.

In various embodiments of the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

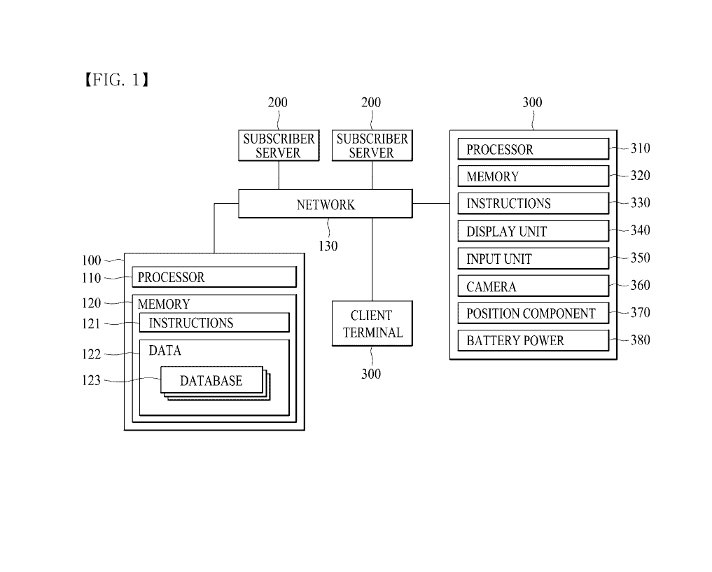

As shown in FIG. 1, a system for providing a 3D content according to an embodiment of the present invention may include an apparatus 100 for providing a 3D content according to an embodiment of the present invention which includes a processor 110 and a memory 120.

In this case, the apparatus 100 for providing a 3D content according to an embodiment of the present invention may perform a communication with a subscriber server 200 and a client terminal 300 through a network 130. The subscriber server 200 is described in detail later.

In order to accomplish such communication through the network 130, the apparatus 100 for providing a 3D content according to an embodiment of the present invention may include a communication module (not shown) configured of at least one of hardware or software. Since such a communication module is a general element which exists in a general purpose computer, a detailed description thereof is omitted.

The memory 120 may store information, including instructions 121 and data 122, which can be accessed by the processor 110 and which may be executed by the processor 110 or may be used in a different way.

The memory 120 may be any type of recording medium that can store information that can be accessed by the processor 110.

For example, the memory 120 may include a hard-drive, a memory card, a flash drive, ROM, RAM, DVD, or other optical disk, or may include other write-enable or read-only memory, but it is not limited thereto.

In this case, the memory 120 may include at least one of a short term storage device (or a temporary storage device) and a long term storage device (or a permanent storage device).

The instructions 121 may be any set of instructions 121 that may be executed directly by the processor 110 as in the case of machine code, or may be performed indirectly as in the case of script.

The terms ‘instructions’ and ‘program’ may be used in this specification interchangeably. The instructions 121 may be stored as an object code format for direct processing by the processor 110, or may be stored as any other computer language that includes scripts or collections of independent source code modules which are analyzed as requested or previously compiled. The functions, methods and routines of the instructions 121 are described in more detail later.

The data 122 may be searched, stored or modified by the processor 110 in accordance with the instruction. For example, architecture is not limited to only any specific data structure, but the data 122 may be stored in a computer register, or may be stored in a relevant database as a table having a plurality of different fields and records, XML documents, or flat files.

Further, the data 122 may be formatted in any computer-readable format. As another example, image data may be stored as bitmaps configured of grids of pixels as well as computer instructions for drawing a graphic, which may be stored according to formats of compression or de compression, lossless or loss, and bitmap or vector-based compression or decompression.

The data 122 may include any sufficient information for identifying relevant information, for example, numbers, descriptive text, proprietary code, references to the data stored in the same memory or in another area of other memories (including other network locations), or information used by a function to compute relevant data.

The processor 110 may be implemented by, for example, the CPU of Intel or Advanced Micro Devices (AMD). Alternatively, the processor 110 may be a dedicated controller such as ASIC, but is not limited thereto.

Although, in FIG. 1, it is functionally illustrated that the processor 110 and the memory 120 are disposed in the same block, it can be easily understood by those skilled in the art that the processor 110 and the memory 120 may actually include a plurality of processors 110 and memories 120 which may be stored or may not be stored in the same physical housing.

For example, the memory 120 may be a hard drive or other storage medium which is located in a server farm of a data center. Thus, it should be understood that a reference to the processor 110, a computer, or the memory 120 may include a set of processors 110, computers, or memories 120 that may operate or may not operate in parallel.

The apparatus 100 for providing a 3D content according to an embodiment of the present invention may be located in a node of the network 130, and may receive data from other nodes of the network 130 directly or indirectly.

For example, the apparatus 100 for providing a 3D content according to an embodiment of the present invention may include a 3D content providing server which can send and receive data with the subscriber server 200 and the client terminal 300 through the network 130.

The 3D content providing server may transmit information to the client terminal 300 by using the network 130, and the information may be displayed on a display unit 340 of the client terminal 300.

For example, the 3D content providing server may transmit preview content and 3D content to the client terminal 300 through the network 130, and the client terminal 300 may display the preview content and the 3D content.

The preview content and the 3D content are described in detail later.

Intermediate nodes between the 3D content providing server and the network 130, between the client terminal 300 and the network 130, and between the subscriber server 200 and the network 130 may include various configurations and may use various protocols. Such protocols may include Internet, World Wide Web, Intranet, a virtual private network, a local Ethernet network, a private network using communication protocols owned by one or more companies, cellular and wireless network (e.g., WiFi), instant messaging, HTTP and SMTP, and various combinations thereof.

Only a few computers are shown in FIG. 1, however, it should be noted that a typical system may include a much larger number of connected computers.

Similarly to the apparatus 100 for providing a 3D content according to an embodiment of the present invention, the client terminal 300 may include a processor 310, a memory 320 and instructions 330. The client terminal 300 may be Personal Computer, PDA, Smart phone, Tablet PC, or Laptop computer which can be connected to the subscriber server 200 and the apparatus 100 for providing a 3D content through the network 130, but it is not limited thereto.

The client terminal 300 may include elements which are typically used in conjunction with a personal computer such as the processor 310 of the client terminal 300, the memory 320 (e.g., RAM and an internal hard drive) storing data and instructions 330, a display unit 340 (e.g., a monitor with a screen, a touch screen, a projector, a television, a computer printer or any other electronic device capable of displaying information), an input unit (e.g., a mouse, a keyboard, a touch-screen or a microphone) 350, and the like.

In addition, the client terminal 300 may include a camera 360, a position component (e.g., a GPS module) 370, an accelerometer (not shown), a speaker (not shown), a network interface device (not shown), a battery power 380 or other power source, and components that are used to connect these elements to other elements.

The apparatus 100 for providing a 3D content according to an embodiment of the present invention may access a database 123 of the 3D content of various objects. At this time, the database 123 may also store the preview content in addition to the 3D content.

In an embodiment of the present invention, the 3D content may be used to virtually introduce a product for sale to a user of the client terminal 300 connected to the subscriber server 200.

In addition, the preview content may also be used to show a 2D or 3D thumbnail image of 3D content before displaying the 3D content through the client terminal 300.

Hereinafter, various operations are described according to aspects of the present invention. It should be understood that the following operations need not to be performed in the order of below description. Alternatively, various steps may be processed in a different order or simultaneously, and steps may be omitted and/or may be added.

The processor 110 of the apparatus 100 for providing a 3D content according to an embodiment of the present invention may transmit the preview content to the client terminal 300, and transmit a 3D content for enlarging a display of the preview content to the client terminal 300 after transmitting the preview content.

A subscriber may be registered in the apparatus 100 for providing a 3D content according to an embodiment of the present invention. At this time, the subscriber may be a seller who desires to sell a product corresponding to the 3D content to a user.

The subscriber may operate the subscriber server 200, and the client terminal 300 may access the subscriber server 200 and may receive a URL of the 3D content from the subscriber server 200, and may access the apparatus 100 for providing a 3D content according to an embodiment of the present invention according to the URL and may receive the 3D content.

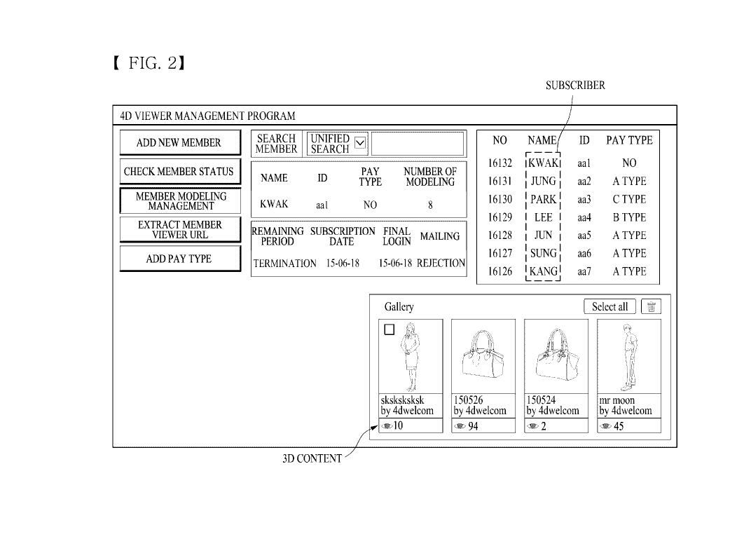

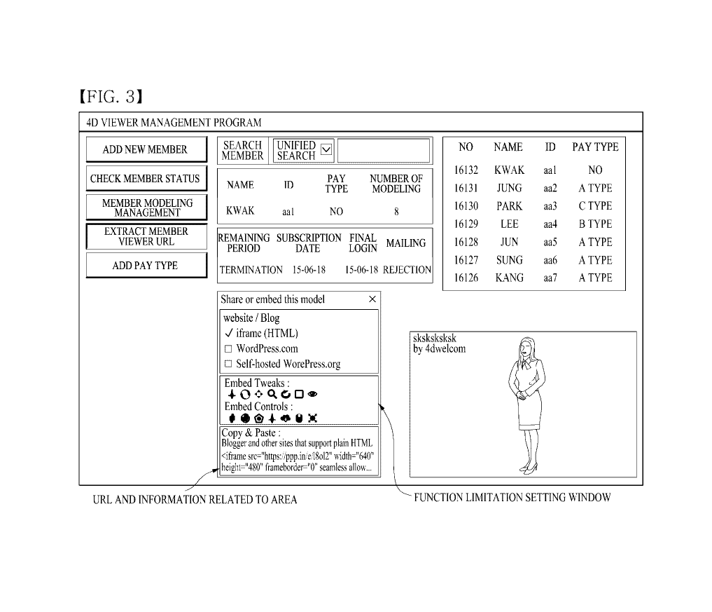

As shown in FIGS. 2 and 3, the above mentioned database 123 may store a 3D content for each subscriber, a Uniform Resource Locator (URL) of 3D content, and information related to area of a web page where a 3D content is displayed. The information related to area is described in detail later.

At this time, the preview content may be stored or may not be stored in the database 123 according to a transmission method of the apparatus 100 for providing a 3D content according to an embodiment of the present invention. When the preview content is stored in the database 123, the URL of the preview content may also be stored in the database 123.

The transmission method of the apparatus 100 for providing a 3D content according to an embodiment of the present invention is described in detail later.

The preview content may be displayed as a 2D image or a three-dimensional image, and accordingly, the client terminal 300 may display the 2D image or the three-dimensional image corresponding to the preview content.

When the preview content and the 3D content are intended to display three-dimensional images, the preview content and the 3D content may include polygon related data and texture related data, and, furthermore, may include various data or information for displaying the preview content and the 3D content.

Meanwhile, when a web browser is installed in the client terminal 300, a 3D acceleration engine included in the web browser may be installed in the client terminal 300, and the 3D acceleration engine may process the preview content and the 3D content.

In this case, the 3D acceleration engine may be a JavaScript based WebGL, and, at this time, the Web Graphics Library (WebGL) may be included in a web browser supporting HTML 5.

In an embodiment of the present invention, the 3D acceleration engine is not limited to WebGL and various 3D acceleration engines included in the web browser may be applied to an embodiment of the present invention.

In this case, the web browser may further include an Application Programming Interface (API) for 3D acceleration engine, and the preview content or the 3D content which provides a three-dimensional image may be designed to be suitable for the API for 3D acceleration engine.

Since the 3D acceleration engine is included in the web browser, the user need not to download and install a separate ActiveX or a flash plug-in for displaying the preview content and three-dimensional images of the 3D content in the client terminal 300.

Next, the transmission of the preview content and the 3D content accomplished between the apparatus 100 for providing a 3D content and the client terminal 300 according to an embodiment of the present invention is illustrated with reference to a drawing.

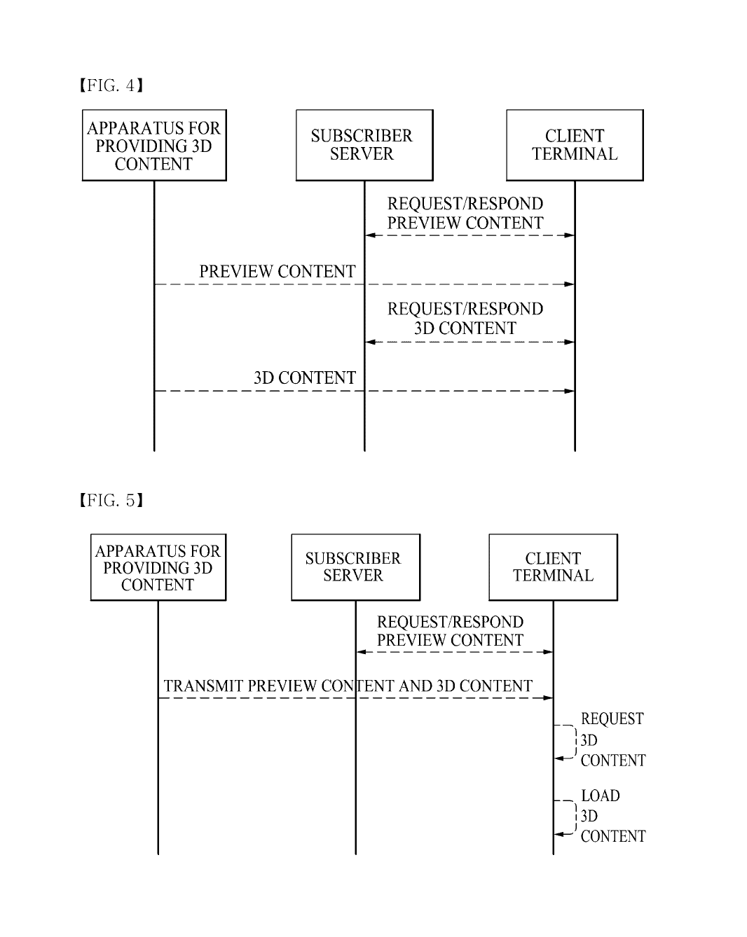

As shown in FIG. 4, as the client terminal 300 accesses a web site provided by the subscriber server 200, the client terminal 300 may request the preview content. Accordingly, the subscriber server 200 may respond to the request by transmitting URL information on the preview content to the client terminal 300.

The client terminal 300 may request the transmission of the preview content to the apparatus 100 for providing a 3D content according to an embodiment of the present invention through the URL information on the preview content.

Accordingly, the apparatus 100 for providing a 3D content according to an embodiment of the present invention may transmit the preview content to the client terminal 300.

In this case, the database 123 of the apparatus 100 for providing a 3D content according to an embodiment of the present invention may store the preview content for the 3D content.

When the client terminal 300 requests the 3D content according to the operation of the input unit 350 of the client terminal 300 by a user, the subscriber server 200 may transmit the URL information on the 3D content to the client terminal 300.

For example, the user may select one of a plurality of preview contents by operating the mouse or the touch panel, and accordingly, the subscriber server 200 may transmit the URL information on the selected 3D content.

The client terminal 300 may request the transmission of the 3D content to the apparatus 100 for providing a 3D content according to an embodiment of the present invention through the URL information on the 3D content.

The processor 110 of the apparatus 100 for providing a 3D content according to an embodiment of the present invention may transmit the 3D content to the client terminal 300.

Thus, the apparatus 100 for providing a 3D content according to an embodiment of the present invention may transmit the preview content to the client terminal 300, and may transmit the 3D content corresponding to the selected preview content to the client terminal 300.

Since the data size of the 3D content may be very large in comparison with the data size of the preview content, transmission traffic may be increased during the transmission of the 3D content.

In an embodiment of the present invention, since the selected 3D content is transmitted after the preview content having a small data size is transmitted, the transmission traffic may be reduced in comparison with the case of transmitting a large amount of 3D content without transmitting the preview content.

Meanwhile, as shown in FIG. 5, as the client terminal 300 accesses a web site provided by the subscriber server 200, the client terminal 300 may request the preview content. Accordingly, the subscriber server 200 may respond to the request by transmitting URL information on the preview content to the client terminal 300.

The client terminal 300 may request the transmission of the preview content to the apparatus 100 for providing a 3D content according to an embodiment of the present invention through the URL information on the preview content.

Accordingly, the apparatus 100 for providing a 3D content according to an embodiment of the present invention may transmit the 3D content corresponding to the preview content as well as the preview content, to the client terminal 300.

The 3D content may be stored in the memory 320 of the client terminal 300 without displaying the 3D content on the client terminal 300, while the preview content is displayed on the client terminal 300. At this time, the processor 310 of the client terminal 300 may set a memory area where the 3D content is stored as the 3D content is stored in the memory 320.

When the 3D content is requested according to the operation of the input unit 350 of the client terminal 300 by the user, the 3D content may be displayed on the client terminal 300. That is, the processor 310 of the client terminal 300 may read and load the 3D content stored in the set memory area.

As described above, when the client terminal 300 accesses the web site provided by the subscriber server 200, the preview content and the 3D content may be transmitted to the client terminal 300.

Accordingly, the traffic for the transmission of the 3D content may be increased. However, since the time for transmitting the 3D content is not required after the user's selection, the time for loading the 3D content to the client terminal 300 after the user's selection may be reduced.

Meanwhile, as shown in FIG. 6, as the client terminal 300 accesses a web site provided by the subscriber server 200, the client terminal 300 may request the preview content. Accordingly, the subscriber server 200 may respond to the request by transmitting URL information on the preview content to the client terminal 300.

The client terminal 300 may request the transmission of the preview content to the apparatus 100 for providing a 3D content according to an embodiment of the present invention through the URL information on the preview content.

Accordingly, the processor 110 of the apparatus 100 for providing a 3D content according to an embodiment of the present invention may generate the preview content by reducing a polygon of the 3D content and transmit to the client terminal 300. At this time, the texture data may also be reduced and transmitted.

In such a case, the database 123 may not store the preview content or may store the preview content generated by the processor 110.

Similarly to the transmission method of FIG. 4, the transmission method of FIG. 6 may also reduce the traffic caused by the transmission of the 3D content.

Meanwhile, when the preview content or the 3D content is transmitted from the apparatus 100 for providing a 3D content according to an embodiment of the present invention to the client terminal 300, the apparatus 100 for providing a 3D content according to an embodiment of the present invention may compress and transmit the preview content or the 3D content. In addition, the client terminal 300 may decompress and display the compressed preview content or 3D content.

In this case, a JSON type supported by HTML 5 may be used as the compression method, but it is not limited thereto.

Meanwhile, the processor 110 of the apparatus 100 for providing a 3D content according to an embodiment of the present invention may control the database 123 including the information related to area of the web page where the 3D content for each subscriber is displayed.

For example, as shown in FIG. 3, the information related to area of the web page may include an iframe corresponding to a tag which defines a zone or the like of a web page that shows the processing result of the 3D data by WebGL.

The information related to area may include setting information of a display function as well as the display location and the display size of the 3D content. For example, as shown in FIG. 3, a part of the functions which can display the 3D content on the client terminal 300 may be limited through a function limitation setting window. The function which can display the 3D content may be the rotation, magnification, movement, or the like of the 3D content, but is not limited thereto.

At this time, the processor 110 may transmit the information related to area of the web page to the client terminal 300 with the transmission of the 3D content.

Accordingly, the apparatus 100 for providing a 3D content according to an embodiment of the present invention may perform a 3D content providing service suitable for each of web sites that provides a large number of subscriber servers 200.

Meanwhile, a plurality of 3D contents having a different data size may be stored in the database 123. The processor 110 of the apparatus 100 for providing a 3D content according to an embodiment of the present invention may select one of the plurality of 3D contents according to the type of the client terminal 300 to transmit to the client terminal 300.

When the client terminal 300 accesses the apparatus 100 for providing a 3D content according to an embodiment of the present invention or the subscriber server 200, the client terminal 300 may receive configuration manifest from the apparatus 100 for providing a 3D content or the subscriber server 200.

The client terminal 300 may process conditional statement of the configuration manifest and transmit information related to specification of the client terminal 300 to the apparatus 100 for providing a 3D content or the subscriber server 200.

The information related to specification of the client terminal 300 may include the type of OS or the type of the client terminal 300 (e.g., personal computer or smart phone), but it is not limited thereto.

Accordingly, the apparatus 100 for providing a 3D content according to an embodiment of the present invention may provide a 3D content suitable for the type of the client terminal 300. For example, since the data processing capability of a personal computer is superior to a smart phone, the data size of the 3D content provided to the personal computer may be larger than the data size of the 3D content provided to the smart phone.

The method for providing a 3D content according to an embodiment of the present invention relates to a technique implemented by a computer to provide the 3D content to be displayed on the client terminal 300.

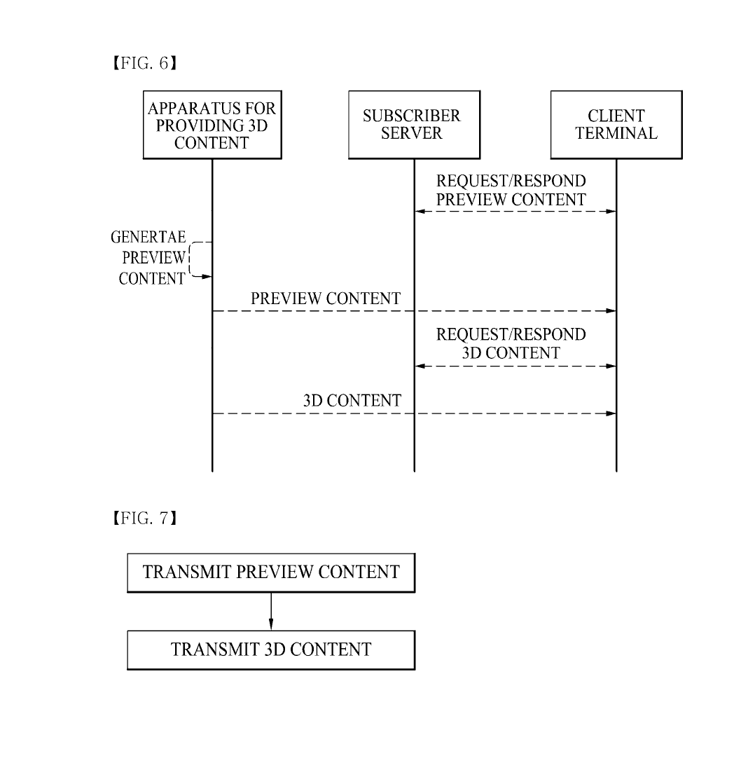

As shown in FIG. 7, the method for providing a 3D content according to an embodiment of the present invention may include a step of transmitting the preview content to the client terminal 300, and a step of transmitting the 3D content for magnifying the preview content to the client terminal 300 after transmitting the preview content.

The client terminal 300 may display a 2D image or a three-dimensional image corresponding to the preview content.

When a web browser is installed in the client terminal 300, a 3D acceleration engine included in the web browser may be installed in the client terminal 300, and the 3D acceleration engine may process the preview content and the 3D content.

When the client terminal 300 requests the 3D content according to the operation of the input unit 350 of the client terminal 300 by a user, the 3D content may be transmitted to the client terminal 300.

When the preview content and the 3D content are transmitted to the client terminal 300, and the preview content is displayed on the client terminal 300, the 3D content may be stored in the memory of the client terminal 300 without being displayed on the client terminal 300, and the 3D content may be displayed on the client terminal 300 when the 3D content is requested according to the operation of the input unit 350 of the client terminal 300 by the user.

The preview content may be generated by reducing the polygons of the 3D content, and the preview content may be transmitted to the client terminal 300.

The method for providing a 3D content according to an embodiment of the present invention may further include a step of reading the information related to area of the web page from the database 123 including the information related to area of the web page where the 3D content for each subscriber is displayed. At this time, the information related to area of the web page may be transmitted to the client terminal 300 with the transmission of the 3D content.

The method for providing a 3D content according to an embodiment of the present invention may further include a step of storing a plurality of 3D content having a different data size in the database 123. At this time, one of the plurality of the 3D contents may be selected and transmitted to the client terminal 300 according to the type of the client terminal 300.

Since these processes were described above in detail with reference to a drawing, a description thereof is omitted.

A recording medium according to an embodiment of the present invention may record a program that performs a function of transmitting the preview content to the client terminal 300 and a function of transmitting the 3D content for magnifying the preview content to the client terminal 300 after transmitting the preview content, and may be read by a computer.

Next, an example of the preview content and the 3D content which are displayed on the client terminal according to the apparatus and the method for providing 3D content, and the recording medium according to an embodiment of the present invention is illustrated with reference to a drawing.

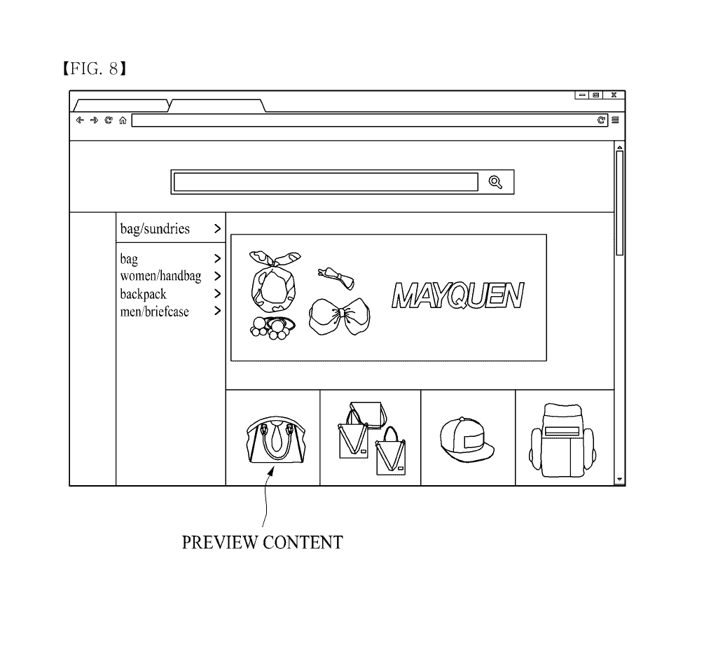

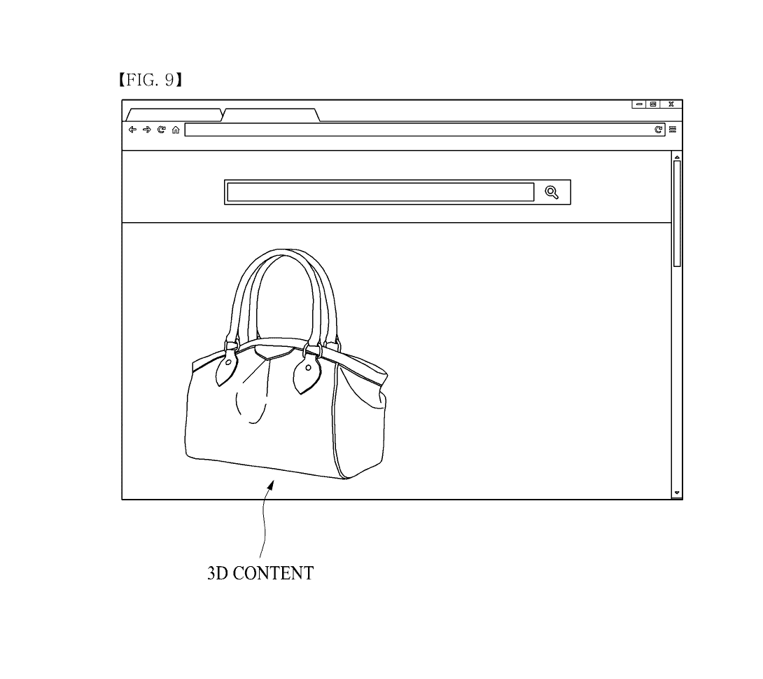

FIG. 8 and FIG. 11 illustrate a preview content displayed on a personal computer and a mobile phone. When the preview content is a 3D image, a user may operate the input unit 350 to rotate the preview content.

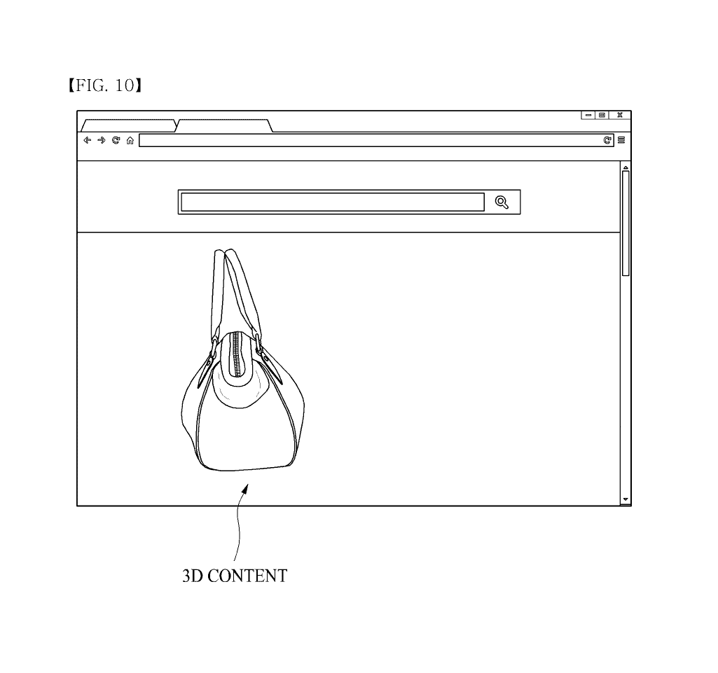

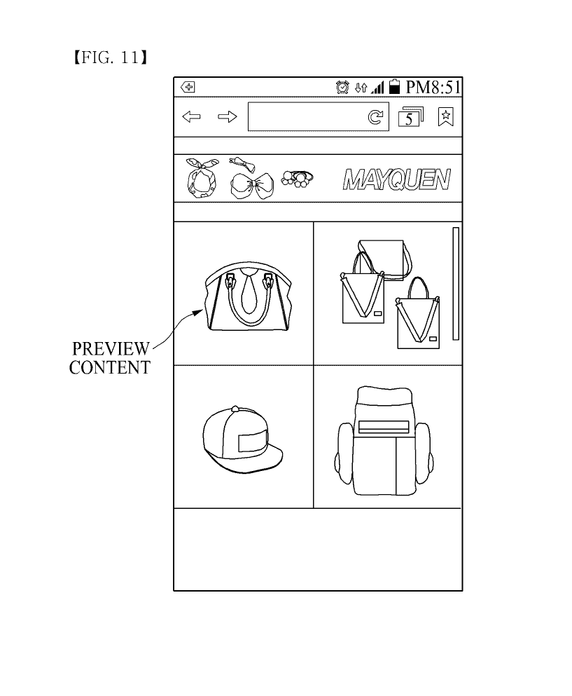

As shown in FIG. 9 and FIG. 10, when a user clicks or touches the preview content through the input unit 350, the 3D content may be displayed on a personal computer which is the client terminal 300. At this time, the user may operate the input unit 350 to view the 3D content in various directions.

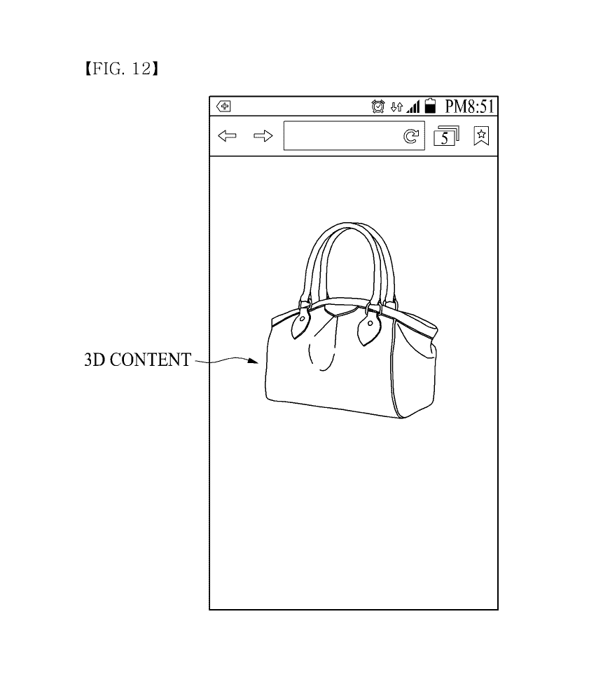

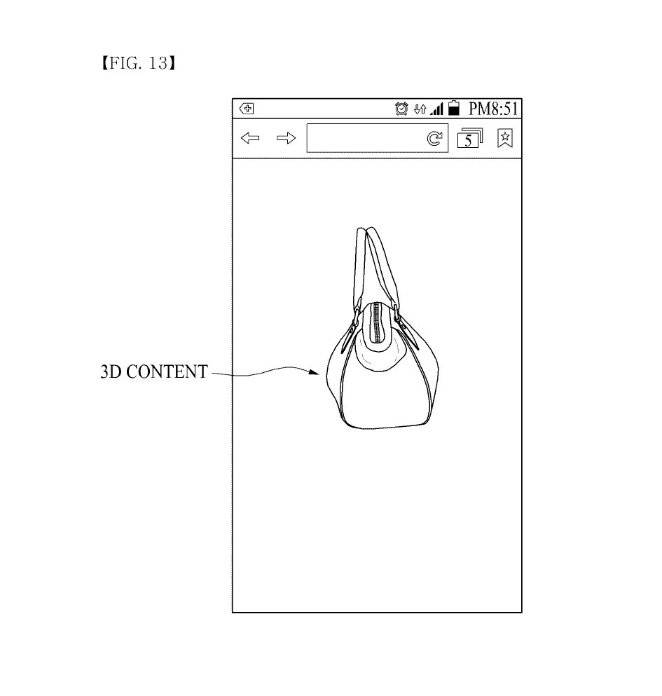

Meanwhile, as shown in FIG. 12 and FIG. 13, the mobile phone may also display the 3D content. The user may operate the input unit 350 of the mobile phone to view the 3D content in various directions.

The apparatus and the method for providing 3D content, and the recording medium according to an embodiment of the present invention may transmit the 3D content after the transmission of the preview content, thereby reducing the traffic or the loading time due to the transmission or loading of the 3D content. Although embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. An apparatus for providing a 3D content, the apparatus comprising:
a processor; and
a memory that can be accessed by the processor,
wherein the processor transmits a preview content to a client terminal, and transmits a 3D content for magnifying the preview content to the client terminal after transmitting the preview content.

2. The apparatus of claim 1, wherein the client terminal displays a 2D image or a three-dimensional image corresponding to the preview content.

3. The apparatus of claim 2, wherein a 3D acceleration engine included in a web browser is installed in the client terminal, when the web browser is installed in the client terminal, and
the 3D engine is able to process the preview content and the 3D content.

4. The apparatus of claim 1, wherein the processor transmits the 3D content to the client terminal, when the client terminal requests the 3D content according to an operation of an input unit of the client terminal by a user.

5. The apparatus of claim 1, wherein the preview content and the 3D content are transmitted to the client terminal, and
the 3D content is stored in a memory of the client terminal without displaying the 3D content on the client terminal while the preview content is displayed on the client terminal, and
the 3D content is displayed on the client terminal, when the 3D content is requested according to an operation of an input unit of the client terminal by a user.

6. The apparatus of claim 1, wherein the processor reduces a polygon of the 3D content to generate the preview content.

7. The apparatus of claim 1, wherein the processor controls a database including information related to area of a web page where the 3D content for each subscriber is displayed, and transmits the information related to area of the web page to the client terminal with the transmission of the 3D content.

8. The apparatus of claim 1, wherein a plurality of the 3D contents having a different data size are stored in a database, and
the processor selects one of the plurality of the 3D contents according to a type of the client terminal to transmit to the client terminal.

9. A method for providing a 3D content implemented in a computer so as to provide the 3D content to be displayed in a client terminal, the method comprising:
transmitting a preview content to the client terminal; and
transmitting the 3D content for magnifying the preview content to the client terminal after transmitting the preview content.

10. The method of claim 9, wherein the client terminal displays a 2D image or a three-dimensional image corresponding to the preview content.

11. The method of claim 10, wherein a 3D acceleration engine included in a web browser is installed in the client terminal, when the web browser is installed in the client terminal, and
the 3D engine is able to process the preview content and the 3D content.

12. The method of claim 9, wherein the 3D content is transmitted to the client terminal, when the client terminal requests the 3D content according to an operation of an input unit of the client terminal by a user.

13. The method of claim 9, wherein the preview content and the 3D content are transmitted to the client terminal, and
the 3D content is stored in a memory of the client terminal without displaying the 3D content on the client terminal while the preview content is displayed on the client terminal, and
the 3D content is displayed on the client terminal, when the 3D content is requested according to an operation of an input unit of the client terminal by a user.

14. The method of claim 9, wherein the preview content is transmitted to the client terminal after generating the preview content by reducing a polygon of the 3D content.

15. The method of claim 9, further comprising reading information related to area of a web page from a database including the information related to area of the web page where the 3D content for each subscriber is displays,
wherein the information related to area of the web page is transmitted to the client terminal with the transmission of the 3D content.

16. The method of claim 9, further comprising storing a plurality of 3D contents having a different data size in a database,
wherein one of the plurality of the 3D contents is selected and transmitted to the client terminal according to a type of the client terminal.

17. A non-transitory computer-readable recording medium recording a program for executing functions of:
transmitting a preview content to a client terminal; and
transmitting a 3D content for magnifying the preview content to the client terminal after transmitting the preview content.

18. The recording medium of claim 17, wherein the 3D content is transmitted to the client terminal, when the client terminal requests the 3D content according to an operation of an input unit of the client terminal by a user.

19. The recording medium of claim 17, wherein the preview content and the 3D content are transmitted to the client terminal, and
the 3D content is stored in a memory of the client terminal without displaying the 3D content on the client terminal while the preview content is displayed on the client terminal, and
the 3D content is displayed on the client terminal, when the 3D content is requested according to an operation of an input unit of the client terminal by a user.

20. The recording medium of claim 17, wherein the preview content is transmitted to the client terminal after generating the preview content by reducing a polygon of the 3D content.
